(19) United States
(12) Patent Application Publication
(10) Pub. No.: US 2012/0318891 A1
(43) Pub. Date: Dec. 20, 2012

(54) SIPHON NOZZLE FOR AIR BLOW GUN

(76) Inventor: Wu-Chiao CHOU, Taichung City (TW)

(21) Appl. No.: 13/160,192

(22) Filed: Jun. 14, 2011

(51) Int. Cl. B05B 1/00

(52) U.S. Cl. 239/291

(57) ABSTRACT

A siphon nozzle for an air blow gun includes at least one first body which has a through hole, a first end and a second end which is located opposite to the first end. The first end of the at least one first body has multiple first siphon holes which communicate with the through hole. The first end is threadedly connected with a nozzle and the second end is connected with a second body having second siphon holes, or connected with more bodies having siphon holes. The siphon holes suck air into the body to increase the flow volume of air.

### FIELD OF THE INVENTION

The present invention relates to a siphon nozzle for an air blow gun, and more particularly, to a siphon nozzle with at least one siphon hole so as to increase the volume of air that blows from the air blow gun.

### BACKGROUND OF THE INVENTION

A conventional air blow gun is shown in FIG. 13 and generally includes a compressor for generating pressurized air which is directly ejected from the air blow gun to remove dust or ash. However, the speed of the pressurized air is very fast and may have the following shortcomings. The first shortcoming is that the blow speed is so fast that the dust is blown up and pollutes the air. The second shortcoming is that the compressor consumes a significant amount of air and energy. The third shortcoming is that the air blows is concentrated air stream which moves so fast that only a limited area can be cleaned. The efficiency of clean is not satisfied. The fourth shortcoming is that the blow speed is so fast that some larger particles could bounce back and hurt the people and the user around.

The present invention intends to provide a siphon nozzle for an air blow gun so as to improve the shortcomings of the conventional air blow guns.

### SUMMARY OF THE INVENTION

The present invention relates to a siphon nozzle for an air blow gun and comprises at least one first body having a through hole, a first end and a second end which is located opposite to the first end. The first end of the at least one first body has multiple first siphon holes which communicate with the through hole. The air blow gun of the present invention increases the area that the air blow gun reaches so as to increase the efficiency of cleaning, and the pressurized air required is reduced so as to reduce the consuming of energy.

Preferably, the inner diameter of the through hole is gradually increased from the first end to the second end so as to increase the area that the pressurized air is ejected.

Preferably, the first siphon hole is inclined relative to the second end so that the air outside of the first siphon holes is brought to the second end of the at least one first body.

Preferably, the air blow gun further comprises a second body which is connected to the second end of the at least one first body. The second body includes multiple second siphon holes defined in a connection portion between the at least one first body and the second body. The second siphon holes communicate with the through hole so as to suck more air and increase the area to be cleaned.

Preferably, the second siphon holes inclinedly communicate with the through hole.

Preferably, the second body includes a vertical face at the connection portion between the at least one first body and the second body, and the second siphon holes are defined in the vertical face. The vertical face is easily machined when compared with inclined faces.

Preferably, the second body has multiple third siphon holes defined therein which are located close to the second siphon holes. The third siphon holes communicate with the through hole.

Preferably, the siphon nozzle further comprises a third body which is connected to the second body. The third body includes multiple third siphon holes which communicate with the through hole so as to suck more air and increase the area to be cleaned.

Preferably, the third siphon holes inclinedly communicate with the through hole.

Preferably, the first end includes inner threads so as to be connected with the air blow gun.

The pressurized air stream at a high speed ejected from the nozzle forms a vacuum area around the siphon holes so that the air outside of the siphon holes is sucked and mixed with the pressurized air stream, such that the volume of the air is increased and the multiple siphon holes significantly increase the air volume. Accordingly, the area that the air stream reaches is increased while the compressor does not increase the air volume it compresses, the energy is also saved.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show the siphon nozzle of the present invention with one-stage of siphon holes;

FIG. 2 is a perspective view to show the siphon nozzle of the present invention with two-stage of siphon holes;

FIG. 3 is a cross sectional view of the second embodiment of the siphon nozzle of the present invention;

FIG. 4 shows that the siphon nozzle of the present invention connected with an air blow gun;

FIG. 5 is a perspective view to show the siphon nozzle of the present invention with three-stage of siphon holes;

FIG. 6 shows that the connection end of the siphon nozzle has outer threads;

FIG. 7 is a cross sectional view of the third embodiment of the siphon nozzle of the present invention;

FIG. 8 is a cross sectional view of the fourth embodiment of the siphon nozzle of the present invention;

FIGS. 9 to 12 show the positions and shapes of the third siphon holes of the siphon nozzle of the present invention, and

FIG. 13 shows a conventional air blow gun.

### DETAILED DESCRIPTION OF THE PREFERRED EMBODIMENT

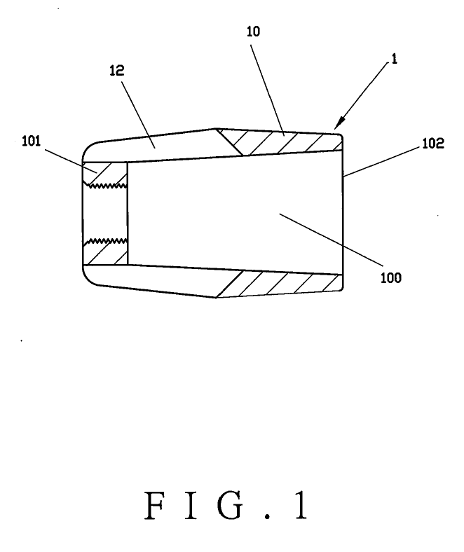

Referring to FIG. 1, the siphon nozzle 1 of the first embodiment of the present invention comprises at least one first body 10 having a through hole 100, a first end 101 and a second end 102 which is located opposite to the first end 101. The inner diameter of the through hole 100 is gradually increased from the first end 101 to the second end 102 so as to increase the area that the pressurized air is ejected. The first end 101 includes inner threads 11 and the first end 101 of the at least one first body 10 has multiple first siphon holes 12 which communicate with the through hole 100. The first siphon holes 12 are inclined relative to the second end 102 so that the air outside of the first siphon holes 12 is brought to the second end 102 of the at least one first body 10. Accordingly, the area that the air stream reaches is increased while the compressor does not increase the air volume it compresses, the energy is also saved.

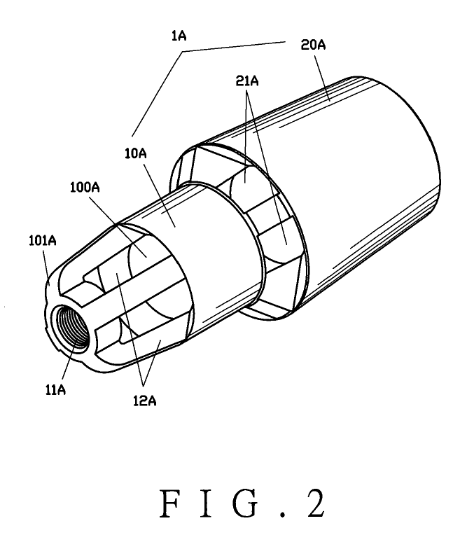

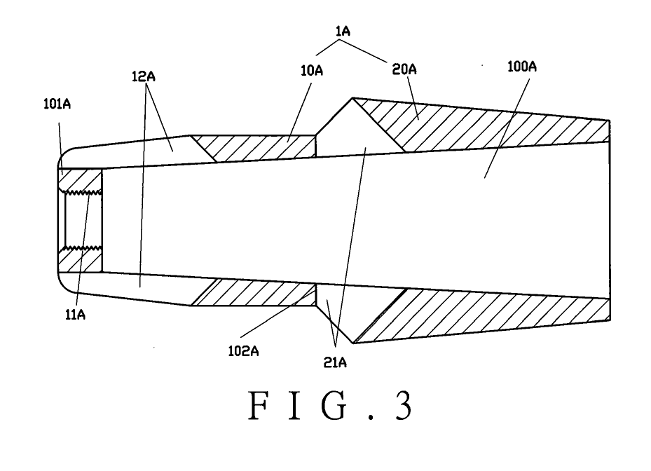

As shown in FIGS. 2 and 3, the second embodiment of the siphon nozzle 1A with two-stage of siphon holes and comprises a first body 10A and a second body 20A. A through hole 100A is defined through the siphon nozzle 1A. The first body 10A has inner threads 11A in the first end 101A thereof and multiple first siphon holes 12A are defined around the first end 101A. The second end 102A of the first body 10A is connected to the second body 20A. The second body 20A includes multiple second siphon holes 21A defined in a connection portion between the at least one first body 10A and the second body 20A. The second siphon holes 21A communicate with the through hole 100A.

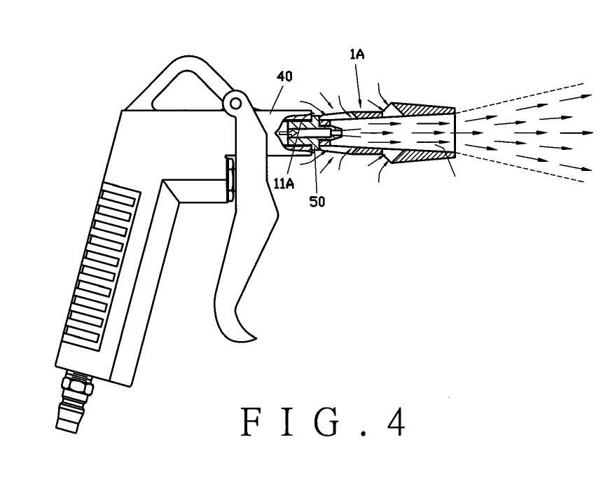

As shown in FIG. 4, the siphon nozzle 1A has inner threads 11A so as to be connected with a nozzle 50 which is threadedly connected to an air blow gun 40. The nozzle 50 ejects the pressurized air stream at a high speed and the volume is 150 liters per minute. A vacuum area is formed around the first siphon holes 12A of the nozzle 50 so as to suck the air outside of the first siphon holes 12A. The sucked air is mixed with the pressurized air stream in the first body 10A. The ejected pressurized air stream is 450 liters per minute, which is three times of the volume of the pressurized air stream before mixed with the air. When the pressurized air stream passes through the second siphon holes 21A of the second body 20A, another vacuum area is formed around the second siphon holes 21A so as to suck the air outside of the second siphon holes 21A. The sucked air is mixed with the pressurized air stream in the second body 20A. The ejected pressurized air stream is 900 to 1200 liters per minute (depend on the increased area of the through hole in the second body 20A) which is 2 to 2.67 times of the volume of the pressurized air stream passing through the first body 10A. When compared with the initial volume of 150 liters per minute, the final volume is 6 to 8 times more than that of the initial volume.

The through hole 100A is gradually bigger from the first body 10A to the second body 20A so as to suck more air and to clean larger area. The efficiency of cleaning the same area is increased by 40 to 50 times when compared with the initial arrangement.

Generally, the air stream for cleaning dust by the volume of 150 liters per minute is sufficient. Because the operation speed of the user cannot be too fast so that the volume of the air stream is set to be 150 liters per minute. Therefore, the volume of the air stream from the nozzle 50 can be reduced to be 18.76 to 25 liters per minute, and the pressurized air that the compressor generates can be reduced 6 to 8 times. The number of the compression of air of the compressor can be reduced and the energy is saved.

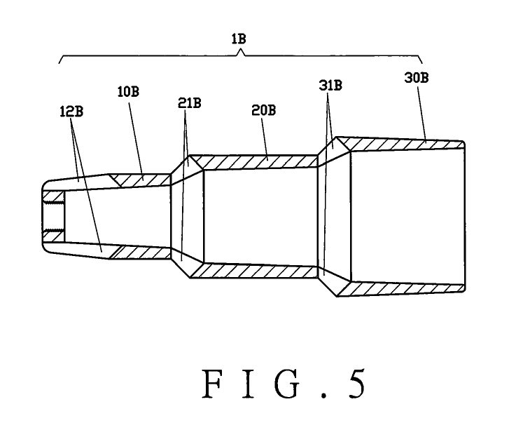

As shown in FIG. 5, the siphon nozzle 1B has a third body 30B which includes multiple third siphon holes 31B. This embodiment still has the first and second bodies 10B, 20B. The first body 10B has multiple first siphon holes 12B and the second body 20B has multiple second siphon holes 21B. The volume from the third body 30B is 1200 to 1800 liters per minute.

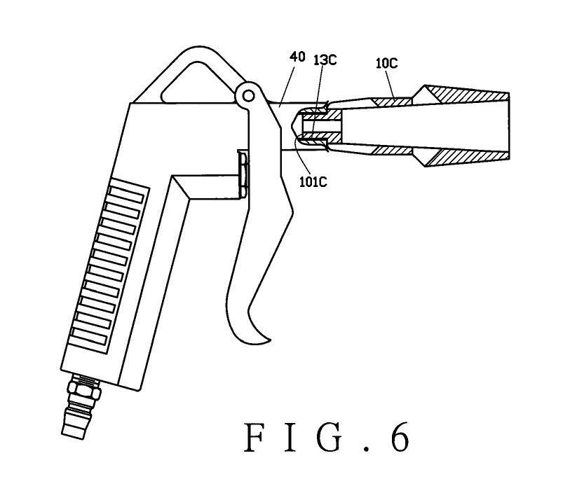

As shown in FIG. 6, the first end 101C of the first body 10C has outer threads 13C which are directly connected to the air blow gun 40 without using the nozzle 50.

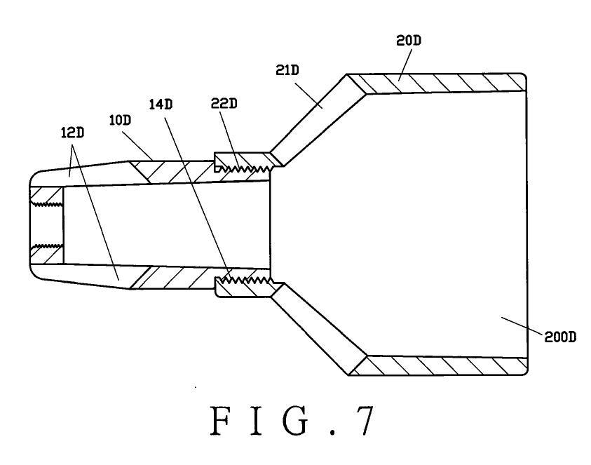

As shown in FIG. 7, the siphon nozzle is composed of the first and second bodies 10D, 20D, wherein the first body 10D has multiple first siphon holes 12D arranged in a circle and the second end of the first body 10D has outer threads 14D. The second body 20D includes inner threads 22D which are connected to the outer threads 14D to connect the first and second bodies 10D, 20D. The second body 20D includes multiple inclined second siphon holes 21D and a through hole 200D with an enlarged inner diameter.

In the embodiment disclosed in FIG. 7, the suction area of the second siphon holes 21D of the second body 20D and the inner diameter of the through hole 200D are increased so as to suck more air to increase the areas to be cleaned and the efficiency of cleaning. The volume of air of the outlet of the second body 20D is 1200 to 1800 liters per minute.

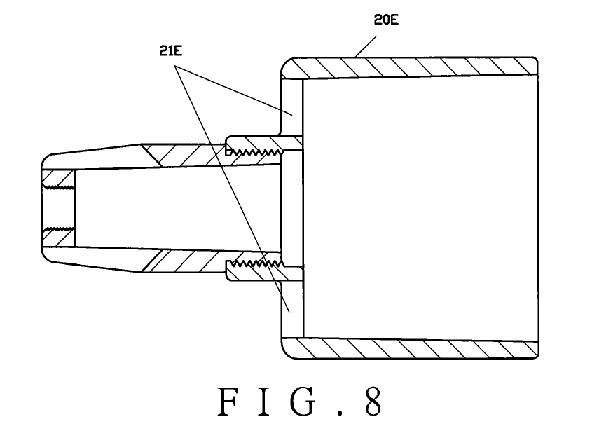

As shown in FIG. 8 which shows an embodiment with the second siphon holes 21E at different positions in the second body 20E. The second body 20E includes a vertical face at the connection portion between the first body and the second body, the second siphon holes 21E are defined in the vertical face. The direction that the air outside is sucked into the second body 20E is parallel to the direction of the air flow in the second body 20E.

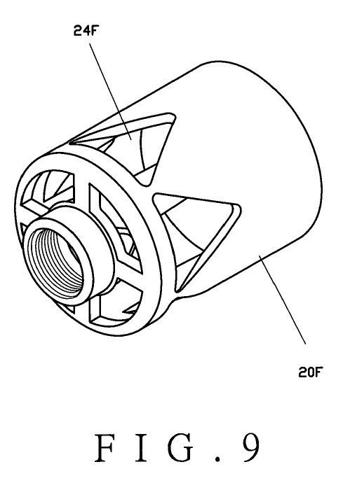

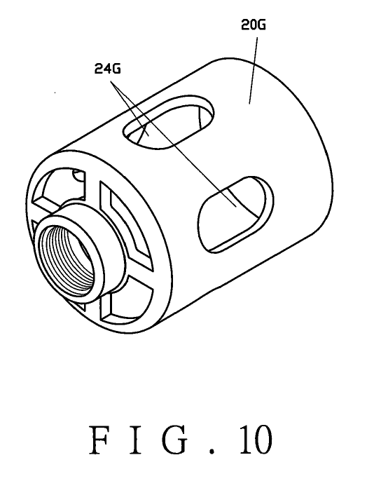

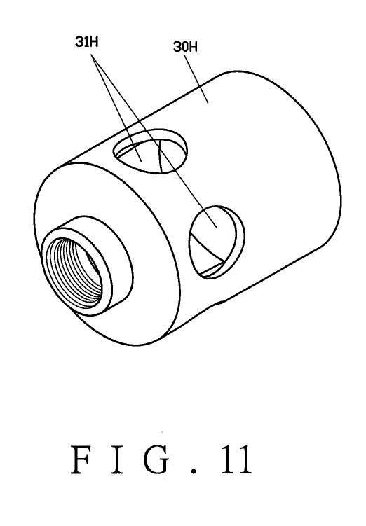

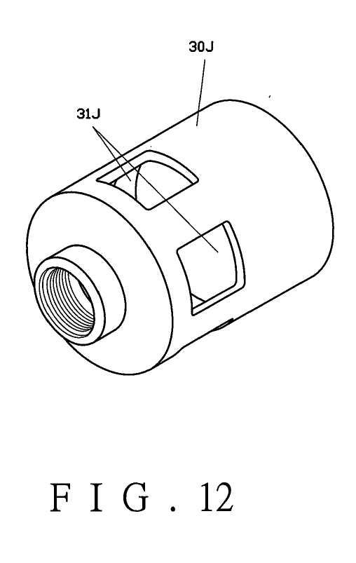

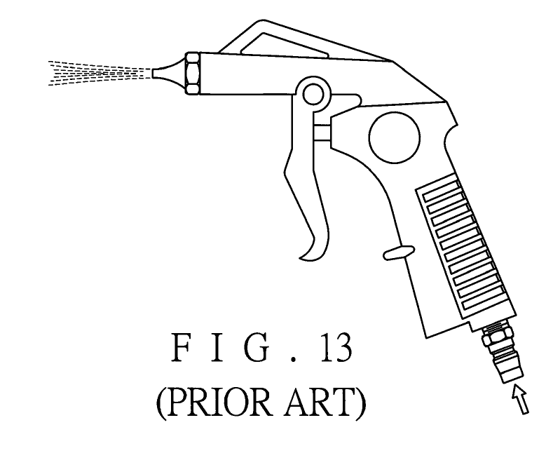

As shown in FIGS. 9 to 12, the shape and the size of the siphon holes of the embodiment are decided according to the air volume to be increased, the shape of the siphon holes can be rectangular, circular or any geometric shape. As shown in FIGS. 9 and 10, the second bodies 20F, 20G respectively have third siphon holes 24F, 24G at the tubular portions thereof so as to increase the air volume to be sucked. The shaped of the third siphon holes 24F, 24G can be triangular and oval. As shown in FIGS. 11 and 12, the shape of the third siphon holes 31H, 31J can be square and circular. The third bodies 30H, 30J respectively have third siphon holes 31H, 31J at the tubular portions thereof. The shape of the third siphon holes 31H, 31J can be triangular, oval, circular, square or any geometric shape. The size can also be varied according needs.

While we have shown and described the embodiment in accordance with the present invention, it should be clear to those skilled in the art that further embodiments may be made without departing from the scope of the present invention.

What is claimed is:

1. A siphon nozzle for an air blow gun, comprising:
at least one first body having a through hole, a first end and a second end which is located opposite to the first end, the first end of the at least one first body having multiple first siphon holes which communicate with the through hole.

2. The siphon nozzle as claimed in claim 1, wherein an inner diameter of the through hole is gradually increased from the first end to the second end.

3. The siphon nozzle as claimed in claim 2, wherein the first siphon holes are inclined relative to the second end.

4. The siphon nozzle as claimed in claim 1, further comprising a second body which is connected to the second end of the at least one first body, the second body including multiple second siphon holes defined in a connection portion between the at least one first body and the second body, the second siphon holes communicating with the through hole.

5. The siphon nozzle as claimed in claim 4, wherein the second siphon holes inclinedly communicate with the through hole.

6. The siphon nozzle as claimed in claim 4, wherein the second body includes a vertical face at the connection portion between the at least one first body and the second body, and the second siphon holes are defined in the vertical face.

7. The siphon nozzle as claimed in claim 4, wherein the second body has multiple third siphon holes defined therein which are located close to the second siphon holes, and the third siphon holes communicate with the through hole.

8. The siphon nozzle as claimed in claim 4, further comprising a third body which is connected to the second body, the third body including multiple third siphon holes which communicate with the through hole.

9. The siphon nozzle as claimed in claim 7, wherein the third siphon holes inclinedly communicate with the through hole.

10. The siphon nozzle as claimed in claim 8, wherein the third siphon holes inclinedly communicate with the through hole.

11. The siphon nozzle as claimed in claim 1, wherein the first end includes inner threads.
